(19) United States
(12) Patent Application Publication
(10) Pub. No.: US 2026/0147386 A1
(43) Pub. Date: May 28, 2026

(54) INFORMATION HANDLING SYSTEM DISPLAY DETACHABLE BEZEL WITH REDUCED REFLECTANCE

(71) Applicant: Dell Products L.P., Round Rock, TX (US)

(72) Inventors: Guentaek Oh, Singapore (SG); Jae Hyun You, Singapore (SG)

(73) Assignee: Dell Products L.P., Round Rock, TX (US)

(21) Appl. No.: 18/958,245

(22) Filed: Nov. 25, 2024

(51) Int. Cl. G06F 1/18; G06F 1/16

(52) U.S. Cl. CPC G06F 1/181; G06F 1/1601

(57) ABSTRACT

A display has a display panel that couples in a frame to present information as visual images with minimal bezel around the perimeter of the display panel. A bottom side of the display panel has a thin stainless steel sheet metal bezel removably coupled by a magnet inserted between the frame and/or display panel and the stainless steel sheet metal bezel. A magnetic Martensite stainless steel used for the bottom bezel magnetically couples in place at the display panel and is removable to support repairs of the display.

### BACKGROUND OF THE INVENTION

### Field of the Invention

The present invention relates in general to the field of information handling system displays, and more particularly to an information handling system display detachable bezel with reduced reflectance.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information to present the information as visual images at a display. Stationary information handling systems have a processor and memory that cooperate to execute instructions in a stationary housing and interact with end users through peripheral input/output (I/O) devices, such as a peripheral keyboard, mouse and display. Portable information handling systems integrate processing components, a display and a power source in a portable housing to support mobile operations. Portable information handling systems allow end users to carry a system between meetings, during travel, and between home and office locations so that an end user has access to processing capabilities while mobile. Portable information handling systems will also typically interact with end users through peripheral I/O devices. As an example, a peripheral display is often preferred for presentation of visual images due to the greater display area than that typically found at an integrated display.

Generally, end users prefer displays that have a full viewing area without an excessive border. Such zero or minimal bezel displays take up less space on the desktop and are more aesthetically pleasing. One way to minimize the bezel size is to decrease the thickness of any protective glass coupled over the display panel by flipping the display panel thin film transistor and color filter layers. FIG. 2 depicts an example of a display panel 52 that has a flip structure. A backlight illuminates through a polarizer 42 and a color filter 40 to provide light that passes through a thin film transistor 36 that generates the visual image. A black matrix 38 between the color filter 40 and thin film transistor 36 defines the edge of the viewing area around the perimeter of the display panel. Light passing through pixels of the thin film transistor layer proceeds through a polarizer 44 that defines the visual image for presentation to an end user. Between the thin film transistor and polarizer 44, copper metal 46 that is used to communicate visual image signals can be visible at the upper side of polarizer 44. In particular, inbound light rays 48 that reflect off of copper metal 46 creates a reflectance 50 that impedes end user viewing of visual images. In one example embodiment, reflectance is twice that of the same display panel having the non-flipped orientation of the color filter at the display panel outer surface. The conventional color filter position does not cause reflectance where external light is absorbed by the black matrix layer placed on the color filter.

One way to reduce display panel reflectance ratio is to have a better mechanical fit and better cosmetics with narrow bezel at the display panel bottom side where copper is present. To achieve a better fit, a thin metal stainless steel or similar metal material is coupled at the display panel bottom side with an adhesive resin between the metal and the panel glass. A difficulty with the use of an adhesive is that removal of the metal bezel to perform repairs often results in damage to the display panel. Generally, if a repair calls for removal of a bezel held by adhesive, the display panel is likely to be discarded, resulting in an expensive and wasteful repair.

### SUMMARY OF THE INVENTION

Therefore, a need has arisen for a system and method which couples a metal bezel to a display without adhesive.

In accordance with the present invention, a system and method are provided which substantially reduce the disadvantages and problems associated with previous methods and systems for coupling a bezel to a display panel. A magnetic martensite stainless steel bezel couples to a display panel with magnetic attraction provided by a magnet at the display frame and/or display panel.

More specifically, an information handling system processes information with a processor and memory that cooperate to execute instructions. The information is presented at a display as visual images. The display couples a display panel in a frame and covers a bottom portion of the display panel with a bezel that hides areas of the display panel that do not present a visual image. The bezel is a thin martensite stainless steel that couples to the display frame with magnetic attraction to a magnet located behind the bezel between the frame and display panel.

The present invention provides a number of important technical advantages. One example of an important technical advantage is that a display couples a display panel in a frame with a bottom side partially covered by an overlap of a bezel at the display panel. The bezel is magnetic martensite stainless steel that is held in place by magnetic attraction of a magnet coupled at the display frame and/or display panel. The display disassembles the display panel by lifting the bezel from the bottom side of the display panel and away from the magnet. Magnetic coupling of the bezel avoids damage to the display panel at disassembly, such as when the display is repaired.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded perspective view of an information handling system interfaced with a peripheral display having a magnetic martensite stainless steel bezel;

FIG. 2 depicts a block diagram of an example of a display panel having a flipped arrangement of display panel layers;

FIG. 3 depicts a side sectional view of a prior art display bezel coupled to a display panel by adhesive;

FIGS. 4 and 4A depict side sectional views of a display having a stainless steel orthogonal shaped bezel magnetically coupled to a display panel bottom side;

FIGS. 5A and 5B depict side sectional views of a display panel bottom side protected by a planar bezel coupled to a planar magnet;

FIG. 6 depicts a side sectional view of a display panel bottom side protected by a planar shaped bezel;

FIG. 7 depicts a side sectional view of a display panel bottom side protected by an alternative embodiment of the orthogonal shaped bezel; and

FIG. 8 depicts a side sectional view of a display panel bottom side protected by an alternative embodiment of the orthogonal shaped bezel.

### DETAILED DESCRIPTION

An information handling system display has a bezel magnetically coupled at a bottom side of a display panel to overlap a color filter and thin film transistor of the display panel. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

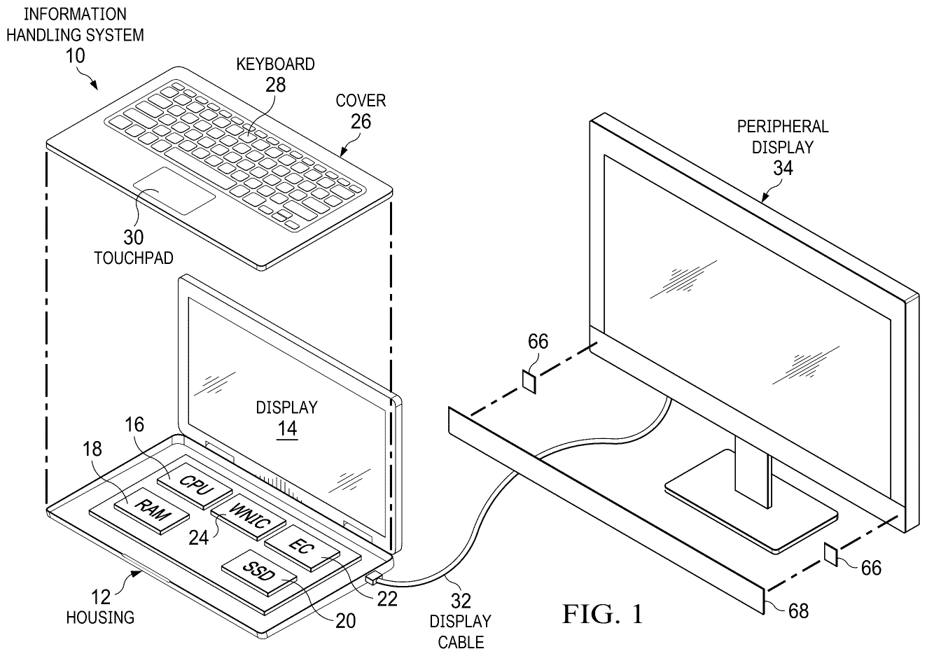

Referring now to FIG. 1, an exploded perspective view depicts an information handling system 10 interfaced with a peripheral display 34 having a magnetic martensite stainless steel bezel 68. In the example embodiment, information handling system 10 has a portable housing that integrates a display 14 in a lid portion. Processing components coupled in the main portion cooperate to process information that is presented at display 14 as visual images. For example, a central processing unit (CPU) 16 executes instructions to process information in cooperation with a random access memory 18 that stores the instructions and information. A solid state drive (SSD) 20 includes non-transitory memory that stores instructions and information during power down of the system, such as an operating system and applications that are retrieved to RAM 18 by an embedded controller 22 during power up. A wireless network interface controller (WNIC) 24 communicates with external devices, such as through Ethernet, WIFI and BLUETOOTH. A housing cover 26 couples to housing 12 to enclose the processing components and support a keyboard 28 and touchpad 30 that accept end user inputs.

In the example embodiment, a display cable 32 interfaces information handling system 10 with a peripheral display 34 that presents information as visual images. To minimize the peripheral display footprint, a narrow bezel surrounds a display panel having a “flipped” display panel layer assembly that exposes copper wire lines to generate reflections at a bottom side of the display panel. A thin bezel 68 couples to peripheral display 34 at the bottom side of the display panel to overlap the portions of the thin film transistor that exposes copper. In the example embodiment, bezel 68 is a planar magnetic martensite stainless steel material, such as SUS 403, that couples to the peripheral display with magnets 66 coupled to the frame of the peripheral display. Although the example embodiment depicts separate individual magnets 66, a magnetic strip that runs the length of the display panel may also be used. Magnets 66 may couple to the display frame by magnetic attraction or may be coupled to the display panel or display panel with adhesive. Magnetic attachment of bezel 68 supports removal of the bezel with a slight prying action that leaves the magnets in place on the display and removes the bezel without any damage to the display panel. Although the example embodiment depicts bezel 68 coupled to the peripheral display, in an alternative embodiment bezel 68 may couple to an integrated display of information handling system 10.

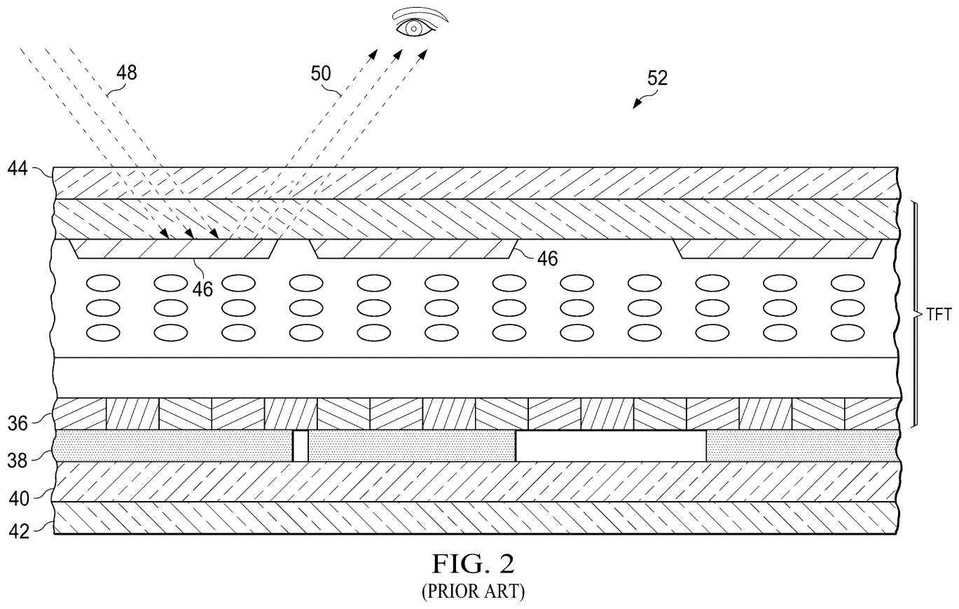

Referring now to FIG. 2, a block diagram depicts an example of a display panel having a flipped arrangement of display panel layers. Conventional display panels have backlight illumination passed through a thin film transistor that manages pixel colors and then passes the light through a color filter. In the flipped display panel 52 structure depicted by FIG. 2, backlight illumination passes through a lower polarizer 42 and then a color filter 40. After the color filter, the light passes through a thin film transistor 36 that defines the visual image and out an upper polarizer 44. Copper metal 46 included in the thin film transistor reflects light rays 48 out as light rays 50 without the benefit of black matrix 38 placed on the display panel edge to cover the electronics.

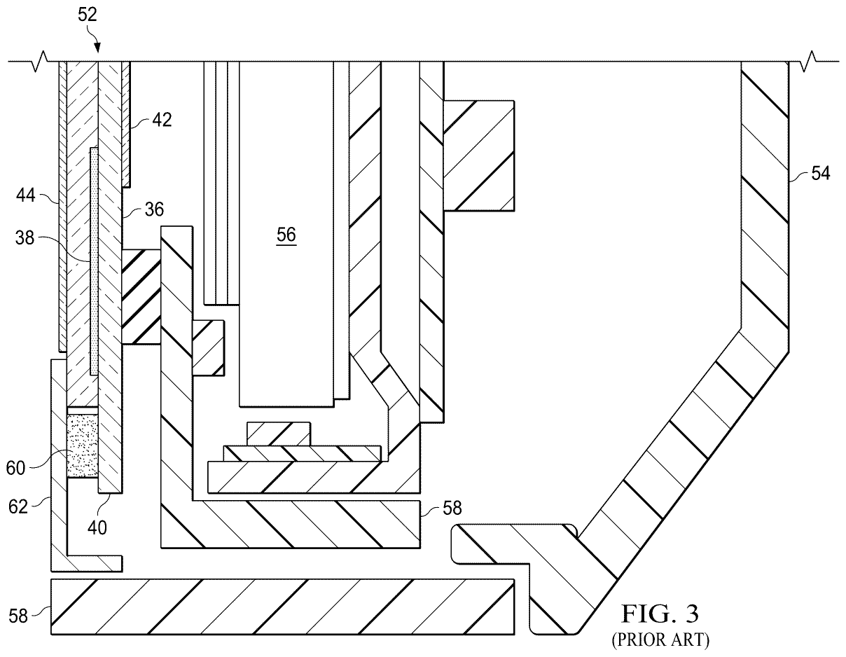

Referring now to FIG. 3, a side sectional view depicts a prior art display bezel 62 coupled to a display panel by adhesive 60. When the display panel 52 couples into display frame 58 at a backlight 56 a bezel 62 couples to the display panel front side with an adhesive 60 located at a color filter 40. Adhesive 60 permanently couples bezel 62 in a position that overlaps the thin film transistor 36 to cover the bottom portion of the display panel that is not hidden by black matrix 38. A rear cover 54 couples at the rear of the display panel. The permanent adhesive holds bezel 62 in place at the display panel so that separation of bezel 62 by pulling on adhesive 60 will likely result in damage to the display panel.

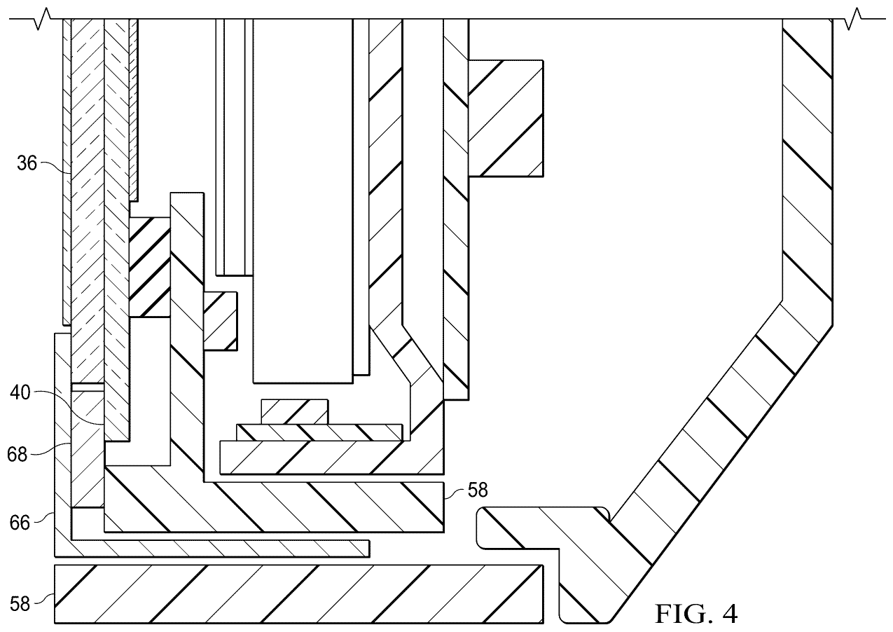

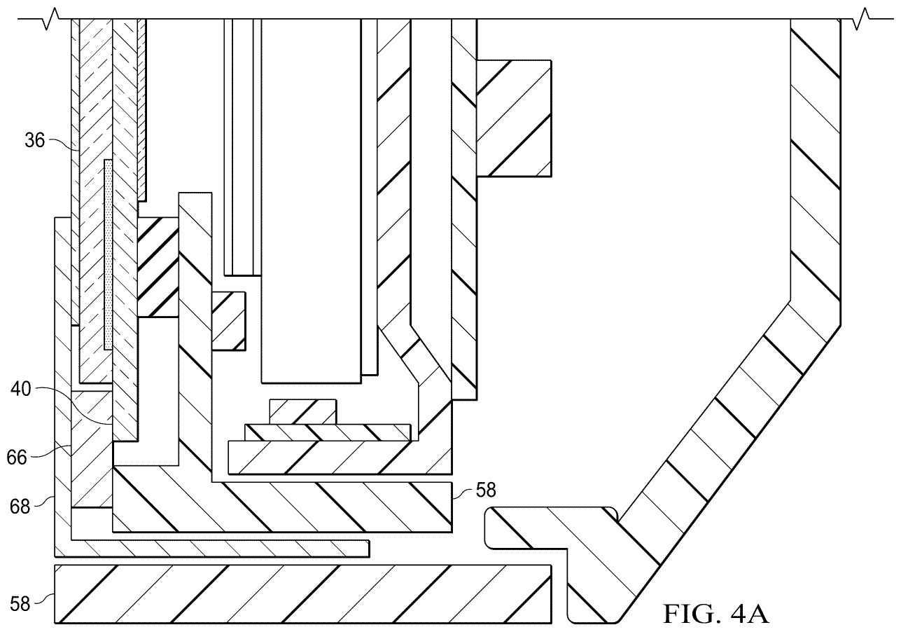

Referring now to FIGS. 4 and 4A, a side sectional view depicts a display panel bottom side protected by an orthogonal shaped bezel 68. The orthogonal shaped bezel 68 is bent martensite stainless steel having a planar front portion that magnetically couples to magnet 66 and an orthogonal portion that projects rearward within a gap formed in frame 58. The display panel presents an appearance of the bezel ending at the frame on the bottom side. Magnet 66 extends from the color filter 40 to rest against the frame front surface above the gap. Magnet 66 may couple in place with adhesive or by magnetic attraction to frame 58. FIG. 4 depicts the bezel aligned with a bottom side of a polarizer applied to the display panel front side. FIG. 4A depicts the bezel overlapping the polarizer at the display panel front side.

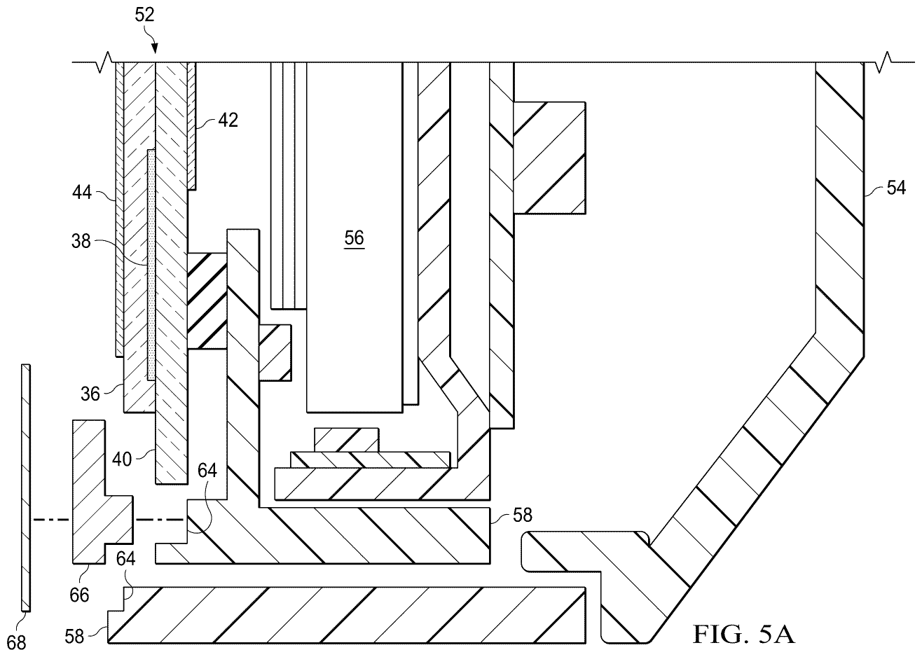

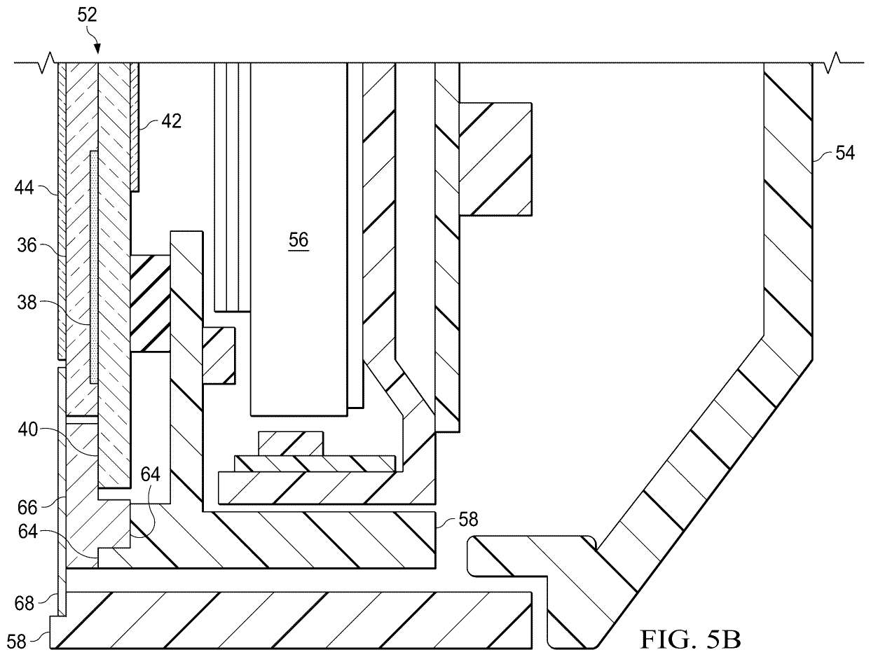

Referring now to FIGS. 5A and 5B, a side sectional view depicts a display having a stainless steel bezel magnetically coupled to a display panel bottom side. FIG. 4A depicts a magnet 66 and a martensite magnetic stainless steel, such as SUS 403, aligned to couple in place at a display panel 52 coupled in a frame 58 and rear cover 54. Frame 58 has a supporting step 64 formed to have a notch structure on which magnet 66 and bezel 68 rest when assembled to display panel 52. Bezel 68 has a thin structure with a length sufficient to extend from the frame bottom step structure up to the start of polarizer 44 on the front side of display panel 52. Magnet 66 has a T shape with a planar front face that couples to bezel 68 and an extension at a rear sides that fits against color filter 40 and frame 58 step 64. FIG. 4B depicts magnet 66 coupled in place to rest on the step 64 of frame 58 and resting against color filter 40 to hold bezel 68 in place with an overlap of thin film transistor 36 up to black matrix 38. The result is an aesthetically pleasing display panel appearance that hides the bottom side of display panel 52 under a strong yet thin bezel 68 made of stainless steel and removable by separation from magnet 66. Magnet 66 may couple by magnetic attraction to frame 58 without the use of any adhesives or may have an adhesive applied.

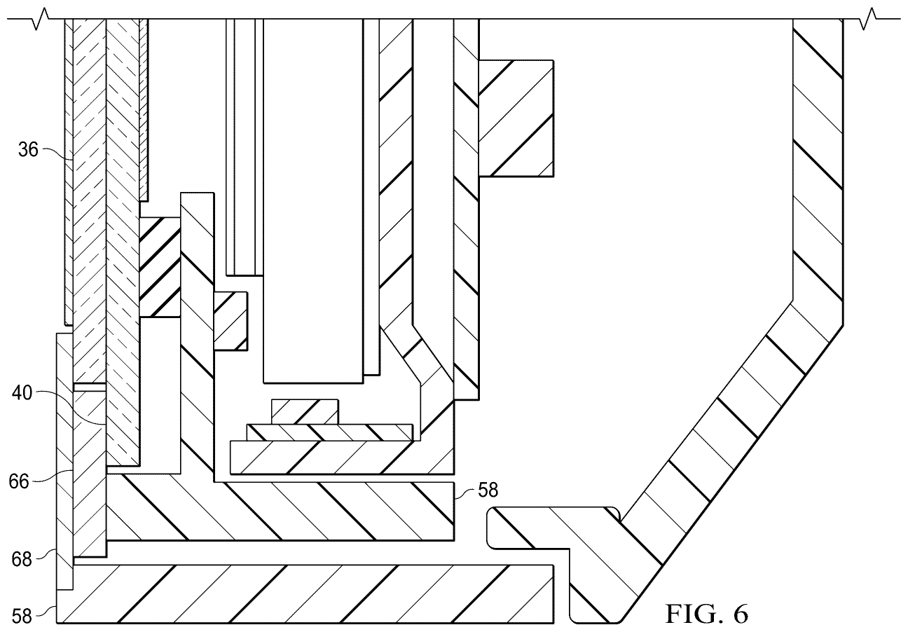

Referring now to FIG. 6, a side sectional view depicts a display panel bottom side protected by a planar bezel 68 coupled to a planar magnet 66. In the example embodiment, planar magnet 66 fits in a slot defined between the bottom of thin film transistor 36 and the bottom of frame 58 at a step so that the rear side of magnet 66 is supported by color filter 40 and frame 58. In one example embodiment, magnet 66 is a flexible tape magnet that couples by an adhesive to color filter 40 and by magnetic attraction to frame 58. Bezel 68 is martensite stainless steel and overlaps thin film transistor 36 at a top side and fits into a step formed in frame 58 at a bottom side.

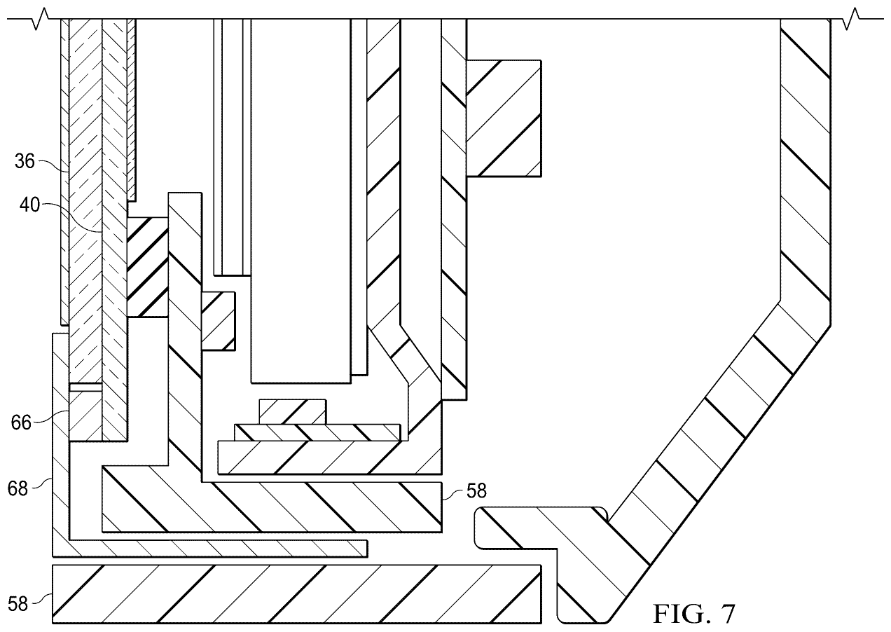

Referring now to FIG. 7, a side sectional view depicts a display panel bottom side protected by an alternative embodiment of the orthogonal shaped bezel 68. A planar portion of bezel 68 couples against magnet 66, which is held by adhesive to color filter 40 so that the bezel planar portion overlaps thin film transistor 36 adjacent the black matrix. Magnet 66 has a smaller size so that frame 58 extends forward to abut against the bezel planar portion. The orthogonal portion of bezel 68 has an increased length to insert into the gap formed in frame 58 to offer increased stability of bezel 68.

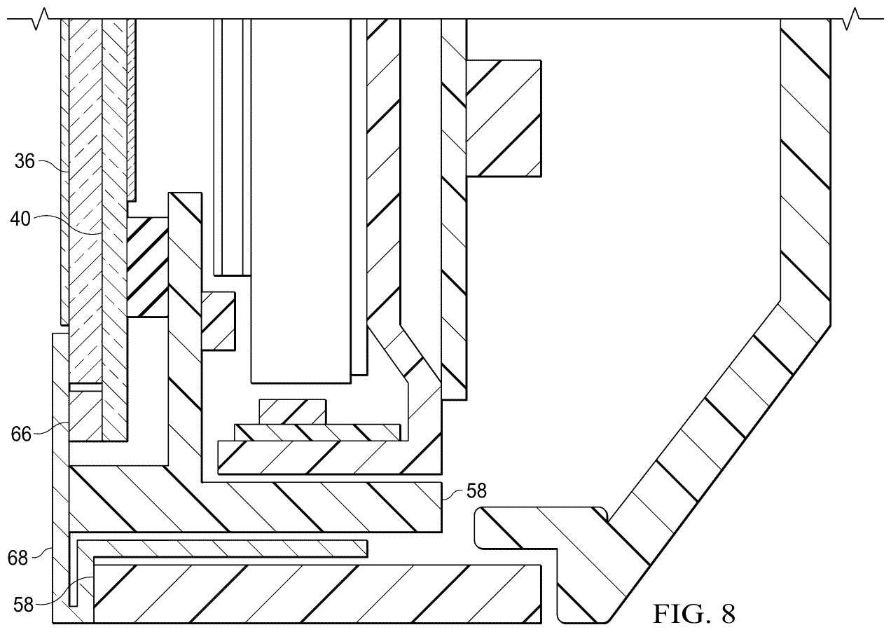

Referring now to FIG. 8, a side sectional view depicts a display panel bottom side protected by an alternative embodiment of the orthogonal shaped bezel 68 having an orthogonal T shape. Bezel 68 has a planar portion that magnetically couples to the display panel with a magnet 66 to overlap thin film transistor 36 and extend down to the bottom side of frame 58. Frame 58 at the bottom has a slight indentation where two bends formed in bezel 68 directs the bezel orthogonal portion back towards the display panel where a third bend inserts an orthogonal portion of bezel 68 into the gap formed in frame 58. The bottom side of the display has a solid bezel appearance without showing the frame and the bezel securely inserts into the frame gap to hold its position.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions to process information;
a display interfaced with the processor and having a display panel coupled in a frame, the display panel presenting the information as visual images;
a magnet coupled to the display frame; and
a martensite stainless steel sheet coupled as a bezel to the display frame by the magnet.

2. The information handling system of claim 1 wherein:
the martensite stainless steel has a planar shape; and
the planar shape covers a portion of the frame at a bottom side and a portion of the display at an upper side.

3. The information handling system of claim 2 wherein:
the frame defines a step; and
the magnet has a T-shape that fits in the step on a first side and a planar shape that couples the martensite stainless steel on a second side.

4. The information handling system of claim 3 wherein the magnet couples the martensite stainless steel without any adhesive.

5. The information handling system of claim 1 wherein:
the martensite stainless steel has a planar shape;
the planar shape covers a portion of the frame at a bottom side and a portion of the display at an upper side; and
the magnet has a planar shape that fits on a top side against a color filter of the display panel and on a bottom side against the frame.

6. The information handling system of claim 1 wherein:
the martensite stainless steel bends to an orthogonal shape;
a planar portion of the orthogonal shape couples by the magnet to the frame and covers a portion of the display panel; and
an orthogonal portion of the orthogonal shape inserts into a gap formed in the frame.

7. The information handling system of claim 1 wherein:
the martensite stainless steel bends to an orthogonal T shape;
a planar portion of the orthogonal T shape couples by the magnet to the frame and covers a portion of the display panel and extends to a bottom side of the frame; and
an orthogonal portion of the orthogonal T shape inserts into a gap formed in the frame between the display panel and the bottom side of the frame.

8. The information handling system of claim 1 wherein the display has a peripheral configuration separate from the housing.

9. The information handling system of claim 1 wherein the display integrates in the housing to have a portable information handling system configuration.

10. A method for coupling a bezel to a display, the method comprising:
coupling a magnet to a bottom side of the display;
forming the bezel from Martensite stainless steel; and
magnetically coupling the bezel to the display at the bottom side and overlapping a display panel of the display with the bezel.

11. The method of claim 10 further comprising:
forming a display frame that holds the display panel to have a step;
forming the magnet to have T-shape with a planar front face to couple the bezel; and
resting the magnet T-shape on the display frame step.

12. The method of claim 10 further comprising:
forming the magnet to have a planar shape;
forming the Martensite stainless steel to have a planar shape;
coupling the magnet to overlap a color filter of the display panel; and
coupling the bezel to the magnet to overlap a thin film transistor of the display panel.

13. The method of claim 10 further comprising:
forming the bezel to have an orthogonal shape;
coupling a planar portion of the bezel to the magnet to overlap the display panel; and
inserting an orthogonal portion of the bezel into a gap formed in a display frame that supports the display panel.

14. The method of claim 13 further comprising:
coupling the magnet to the display panel color filter with adhesive.

15. The method of claim 10 further comprising:
forming the bezel to have an orthogonal T shape;
coupling a planar portion of the orthogonal T shape to the magnet to overlap a thin film transistor of the display panel and extend away from the display panel to an end of a display frame; and
inserting an orthogonal portion of the orthogonal T shape into a gap formed in the display frame between the display panel and the end of the display frame.

16. A display comprising:
a frame;
a display panel coupled in the frame, the display panel presenting information as visual images;
a magnet coupled to the frame; and
a martensite stainless steel sheet coupled as a bezel to the display frame by the magnet.

17. The display of claim 16 wherein:
the martensite stainless steel has a planar shape;
the planar shape covers a portion of the frame at a bottom side of the planar shape and a portion of the display at an upper side of the planar shape;
the frame defines a step; and
the magnet has a T-shape that fits in the step on a first side and a planar shape that couples the martensite stainless steel on a second side.

18. The display of claim 16 wherein:
the martensite stainless steel has a planar shape;
the planar shape covers a portion of the frame at a bottom side and a portion of the display at an upper side; and
the magnet has a planar shape that fits on a top side against a color filter of the display panel and on a bottom side against the frame.

19. The display of claim 16 wherein:
the martensite stainless steel bends to an orthogonal shape;
a planar portion of the orthogonal shape couples by the magnet to the frame and covers a portion of the display panel; and
an orthogonal portion of the orthogonal shape inserts into a gap formed in the frame.

20. The display of claim 16 wherein:
the martensite stainless steel bends to an orthogonal T shape;
a planar portion of the orthogonal T shape couples by the magnet to the frame and covers a portion of the display panel and extends to a bottom side of the frame; and
an orthogonal portion of the orthogonal T shape inserts into a gap formed in the frame between the display panel and the bottom side of the frame.
